(19) United States
(12) Patent Application Publication
(10) Pub. No.: US 2015/0065248 A1
(43) Pub. Date: Mar. 5, 2015

(54) Audio Controller for Gaming and Telephony

(71) Applicant: Plantronics, Inc., Santa Cruz, CA (US)

(72) Inventors: Joshua LaTendresse, San Jose, CA (US); Robert Foster, Scotts Valley, CA (US); Nicholas Paterson, Santa Cruz, CA (US); Carrianne Minick, San Jose, CA (US); Wei Hai, San Jose, CA (US)

(73) Assignee: Plantronics, Inc., Santa Cruz, CA (US)

(21) Appl. No.: 13/965,018

(22) Filed: Aug. 30, 2013

(51) Int. Cl. A63F 13/40

(52) U.S. Cl. CPC A63F 13/10
USPC 463/35

(57) ABSTRACT

Apparatus having corresponding methods comprise: an audio mixer; a game chat output interface configured to transmit game chat output audio from the apparatus; a mobile output interface configured to transmit mobile output audio from the apparatus; a microphone interface configured to receive microphone audio into the apparatus; and wherein, responsive to selection of a first mode, the audio mixer is configured to provide the game chat output audio based on the microphone audio; and wherein, responsive to selection of a second mode, the audio mixer is further configured to provide the mobile output audio based on the microphone audio.

### BACKGROUND

The present disclosure relates generally to audio mixing, balancing, and control. More particularly, the present disclosure relates to audio mixing, balancing, and control for game devices and other devices.

Multiplayer online games are enjoying rapidly-expanding popularity. Some games currently have over ten million subscribers, and log over a billion hours of game play per year. These games generally provide a virtual world such as a battle arena. The players generally assume roles and form teams in the virtual world. The players on a team may communicate to achieve an objective. This communication is generally referred to as “game chat.” Multiplayer online games are generally long and intense, sometimes lasting several hours. This situation presents players with something of a dilemma. Players are reluctant to leave the game for fear of missing important action, but are also eager to stay in touch with friends by using their smartphones to conduct phone calls, receive notifications from social media sites, and the like.

### SUMMARY

In general, in one aspect, an embodiment features an apparatus comprising: an audio mixer; a game chat output interface configured to transmit game chat output audio from the apparatus; a mobile output interface configured to transmit mobile output audio from the apparatus; a microphone interface configured to receive microphone audio into the apparatus; and wherein, responsive to selection of a first mode, the audio mixer is configured to provide the game chat output audio based on the microphone audio; and wherein, responsive to selection of a second mode, the audio mixer is further configured to provide the mobile output audio based on the microphone audio.

Embodiments of the apparatus can include one or more of the following features. Some embodiments comprise a mobile input interface configured to receive mobile input audio into the apparatus; and an earphone interface configured to transmit earphone audio from the apparatus; wherein the audio mixer is further configured to provide the earphone audio based on the mobile input audio. Some embodiments comprise a game chat input interface configured to receive game chat input audio into the apparatus; wherein, responsive to selection of the first mode, the audio mixer is further configured to provide the game chat input audio to the earphone interface. In some embodiments, the audio mixer is further configured to provide the game chat input audio to the earphone interface responsive to i) selection of the second mode, and ii) selection of a combo mixing mode. Some embodiments comprise a game sound interface configured to receive game sound audio into the apparatus; wherein the audio mixer is further configured to provide the game sound audio to the earphone interface. In some embodiments, the audio mixer comprises: a balancer configured to change an audio level balance between the game chat input audio and the game sound audio. Some embodiments comprise a potentiometer configured to change a gain of the mobile input audio in accordance with a position of the potentiometer. In some embodiments, the balancer is a first balancer, and wherein the audio mixer further comprises: a second balancer configured to change a gain of the game chat input audio and the game sound audio in accordance with the position of the potentiometer responsive to selection of the second mode. Some embodiments comprise a signal processor configured to process at least one of i) the earphone audio prior to the earphone interface transmitting the earphone audio from the apparatus, ii) the game chat output audio prior to the game chat output interface transmitting the game chat output audio from the apparatus, and iii) the mobile output audio prior to the mobile output interface transmitting the mobile output audio from the apparatus. Some embodiments comprise a mobile device controller configured to cause a mobile device connected to the mobile input interface to perform at least one of i) answering a call, ii) ending a call, iii) starting music play, and iv) ending music play. Some embodiments comprise an integrated circuit comprising the audio mixer.

In general, in one aspect, an embodiment features a method for an audio controller, wherein the method comprises: transmitting game chat output audio from a game chat output interface of the audio controller; transmitting mobile output audio from a mobile output interface of the audio controller; and receiving microphone audio into a microphone interface of the audio controller; providing the game chat output audio based on the microphone audio responsive to selection of a first mode; and providing the mobile output audio based on the microphone audio responsive to selection of a second mode.

Embodiments of the method can include one or more of the following features. Some embodiments comprise receiving mobile input audio into a mobile input interface of the audio controller; transmitting earphone audio from an earphone interface of the audio controller; and providing the earphone audio based on the mobile input audio. Some embodiments comprise receiving game chat input audio into a game chat input interface of the audio controller; and providing the game chat input audio to the earphone interface responsive to selection of the first mode. Some embodiments comprise providing the game chat input audio to the earphone interface responsive to i) selection of the second mode, and ii) selection of a combo mixing mode. Some embodiments comprise receiving game sound audio into a game sound interface of the audio controller; and providing the game sound audio to the earphone interface. Some embodiments comprise changing an audio level balance between the game chat input audio and the game sound audio. Some embodiments comprise changing a gain of the mobile input audio in accordance with a position of the potentiometer. Some embodiments comprise changing a gain of the game chat input audio and the game sound audio in accordance with the position of the potentiometer responsive to selection of the second mode. Some embodiments comprise processing, in a signal processor of the audio controller, at least one of i) the earphone audio prior to the earphone interface transmitting the earphone audio from the apparatus, ii) the game chat output audio prior to the game chat output interface transmitting the game chat output audio from the apparatus, and iii) the mobile output audio prior to the mobile output interface transmitting the mobile output audio from the apparatus.

In general, in one aspect, an embodiment features an apparatus comprising: a user-operable switch having a first position and a second position; and an audio mixer; wherein, responsive to the user-operable switch being in the first position, the audio mixer is configured to provide game chat output audio based on microphone audio received by the audio mixer; and wherein, responsive to the user-operable switch being in the second position, the audio mixer is further configured to provide mobile output audio based on the microphone audio.

Embodiments of the apparatus can include one or more of the following features. In some embodiments, the audio mixer is further configured to provide earphone audio based on the mobile input audio. In some embodiments, responsive to the user-operable switch being in the first position, the audio mixer is further configured to provide the earphone audio based on game chat input audio received by the audio mixer. Some embodiments comprise a user-operable button; wherein the audio mixer is further configured to provide the earphone audio based on the game chat input audio responsive to i) operation of the user-operable button, and ii) the user-operable switch being in the second position. In some embodiments, the audio mixer is further configured to provide the earphone audio based on game sound audio received by the apparatus. Some embodiments comprise a user-operable slide control; wherein, responsive to operation of the user-operable slide control, the audio mixer is further configured to change an audio level balance between the game chat input audio and the game sound audio. In some embodiments, the user-operable slide control is a first user-operable slide control, and the apparatus further comprises: a second user-operable slide control; and a potentiometer configured to change a gain of the mobile input audio responsive to operation of the second user-operable slide control. In some embodiments, the audio mixer is further configured to change a gain of the game chat input audio and the game sound audio responsive to i) operation of the second user-operable slide control, and ii) the user-operable switch being in the second position. Some embodiments comprise a mobile device controller; and a user-operable mobile control button; wherein, responsive to operation of the user-operable mobile control button, the mobile device controller is configured to cause a mobile device connected to the apparatus to perform at least one of i) answering a call, ii) ending a call, iii) starting music play, and iv) ending music play. Some embodiments comprise a user-operable dial, wherein the audio mixer is further configured to change a gain of the earphone audio responsive to operation of the user-operable dial. Some embodiments comprise an integrated circuit comprising the audio mixer.

In general, in one aspect, an embodiment features a method for an audio controller, wherein the method comprises: providing game chat output audio based on microphone audio received by the audio controller responsive to a user-operable switch being in a first position; providing mobile output audio based on the microphone audio responsive to the user-operable switch being in a second position. Some embodiments comprise providing earphone audio based on mobile input audio received by the audio controller. Some embodiments comprise providing the earphone audio based on game chat input audio received by the audio controller responsive to the user-operable switch being in the first position. In some embodiments, the audio mixer is further configured to provide the earphone audio based on the game chat input audio responsive to i) operation of a user-operable button, and ii) the user-operable switch being in the second position. Some embodiments comprise providing the earphone audio based on game sound audio received by the audio controller. Some embodiments comprise changing an audio level balance between the game chat input audio and the game sound audio responsive to operation of a user-operable slide control. In some embodiments, the user-operable slide control is a first user-operable slide control, and the method further comprises: changing a gain of the mobile input audio responsive to operation of a second user-operable slide control. Some embodiments comprise changing a gain of the game chat input audio and the game sound audio responsive to i) operation of the second user-operable slide control, and ii) the user-operable switch being in the second position. Some embodiments comprise, responsive to operation of a user-operable mobile control button, causing a mobile device connected to the audio controller to perform at least one of i) answering a call, ii) ending a call, iii) starting music play, and iv) ending music play.

The details of one or more implementations are set forth in the accompanying drawings and the description below. Other features will be apparent from the description and drawings, and from the claims.

### DESCRIPTION OF DRAWINGS

FIG. 1 illustrates one use case for the disclosed audio controllers.

FIG. 2 shows example audio connections for an embodiment where the game device is a personal computer.

FIG. 3 shows example audio connections for an embodiment where the game device is an XBOX 360 device.

FIG. 4 shows example audio connections for such an embodiment where the game device is a PLAYSTATION 3 (PS3) device.

FIG. 5 shows detail of an audio controller according to one embodiment.

FIG. 6 illustrates audio flows for the audio controller of FIG. 5 when operating in the game mode according to one embodiment.

FIG. 7 illustrates audio flows for the audio controller of FIG. 5 when operating in the mobile mode according to one embodiment.

FIG. 8 illustrates audio flows for the audio controller of FIG. 5 when operating in the mobile mode with combo sound according to one embodiment.

FIG. 9 shows a process for the audio controller of FIG. 5 according to one embodiment.

FIG. 10 shows user-operable controls and user-perceivable indicators of an audio controller according to one embodiment.

FIG. 11 illustrates mixing and balancing for the game mode according to one embodiment.

FIG. 12 illustrates mixing and balancing for the mobile mode according to one embodiment.

FIG. 13 illustrates mixing and balancing for the mobile mode with combo sound according to one embodiment.

FIG. 14 shows detail of the first balancer of the audio controller of FIG. 11 according to one embodiment.

FIG. 15 shows gain profiles for the first balancer of FIG. 11 in the game mode and mobile mode with combo sound according to one embodiment.

FIG. 16 shows detail of the second balancer of the audio controller of FIG. 11 according to one embodiment.

FIG. 17 shows gain profiles for the second balancer of FIG. 11 in the mobile mode with combo sound according to one embodiment.

FIG. 18 shows a process for the audio controller of FIG. 10 according to one embodiment.

FIG. 19 is a perspective view of an audio controller device according to one embodiment.

FIG. 20 is a front view of an audio controller device according to one embodiment.

FIG. 21 is a rear view of an audio controller device according to one embodiment.

FIG. 22 is a left side view of an audio controller device according to one embodiment.

FIG. 23 is a right side view of an audio controller device according to one embodiment.

FIG. 24 is a top view of an audio controller device according to one embodiment.

FIG. 25 is bottom view of an audio controller device according to one embodiment.

FIG. 26 is a perspective view of an audio controller device according to one embodiment.

FIG. 27 is a front view of an audio controller device according to one embodiment.

FIG. 28 is a rear view of an audio controller device according to one embodiment.

FIG. 29 is a left side view of an audio controller device according to one embodiment.

FIG. 30 is a right side view of an audio controller device according to one embodiment.

FIG. 31 is a top view of an audio controller device according to one embodiment.

FIG. 32 is bottom view of an audio controller device according to one embodiment.

The leading digit(s) of each reference numeral used in this specification indicates the number of the drawing in which the reference numeral first appears.

### DETAILED DESCRIPTION

Embodiments of the present disclosure provide audio controllers that may be used for gaming, telephony, and the like. While the disclosed audio controllers are described in terms of gaming and mobile devices, it will be understood that the disclosed audio controllers may be used with any audio devices. Furthermore, while a use case for gaming and mobile devices is described in detail herein, it will be understood that the disclosed audio controllers may be employed in a variety of other use cases.

The disclosed audio controllers have multiple modes that allow players in multiplayer online games to answer telephone calls without interrupting game play. In a first mode, referred to herein as “game mode,” the audio controllers provide a user with game sound and two-way game chat. In a second mode, referred to herein as “mobile mode,” the audio controllers provide game sound while allowing the user to conduct phone calls. In a third mode, referred to herein as “mobile mode with combo sound,” the audio controllers provide game sound and incoming game chat while allowing the user to conduct phone calls. The terms “game mode,” “mobile mode,” and “mobile mode with combo sound” are used for clarity in the described use case, and are not intended to limit the use cases for the disclosed audio controllers in any way.

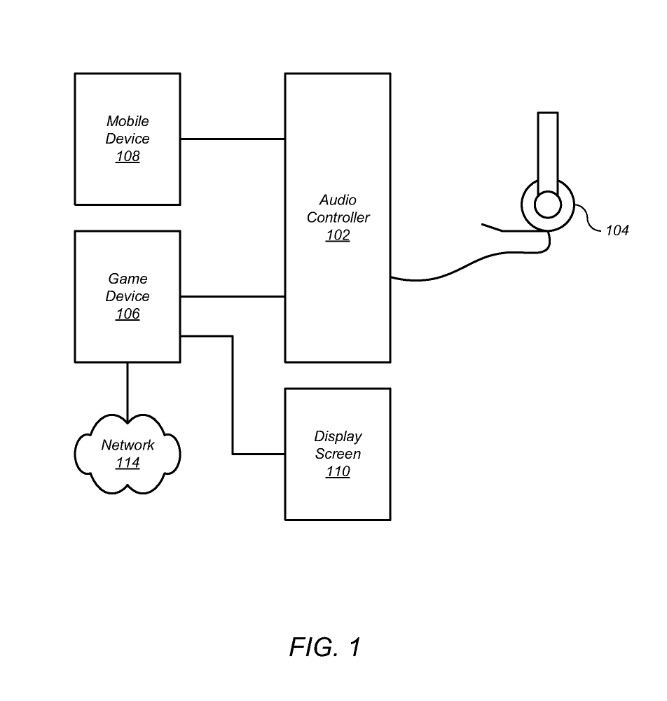

FIG. 1 illustrates one use case for the disclosed audio controllers. Although in the described embodiments, the elements of the audio controller are presented in one arrangement, other embodiments may feature other arrangements, as will be apparent to one skilled in the relevant arts based on the disclosure and teachings provided herein. For example, the elements of the audio controllers can be implemented in hardware, software, or combinations thereof. Referring to FIG. 1, an audio controller 102 may be connected to a headset 104, a game device 106, and a mobile device 108. The mobile device 108 may be any sort of device capable of the functions described herein, for example including a smartphone, mobile phone, tablet computer, music player, or the like. In any of the embodiments described herein, the described headsets may be replaced with other sorts of speakers and microphones. The game device 106 may also be connected to a display screen 110 and a network 114 such as the Internet. The game device 106 may provide video to the display screen 110. The game device 106 may also exchange audio with the audio controller 112, as discussed in detail below. As used herein, the term “audio” refers to an electrical, optical, or other representation of sound.

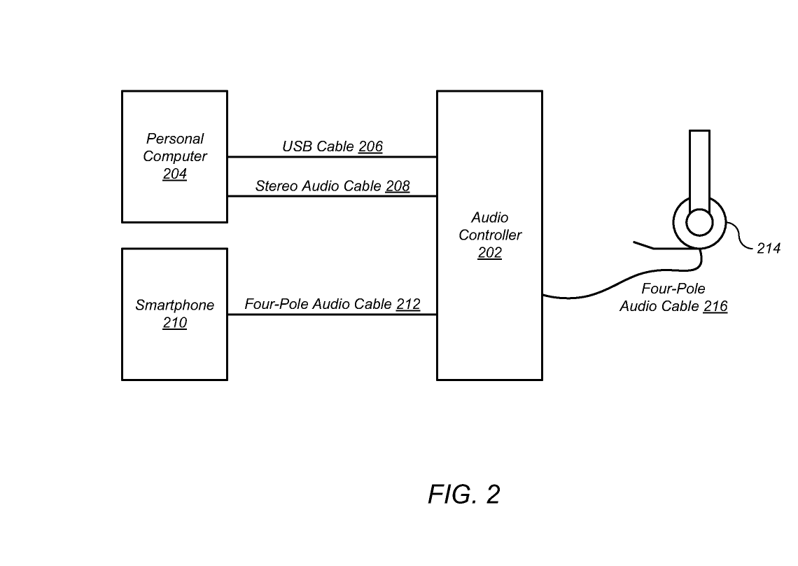

The game device 106 may be any sort of game device. In one embodiment, the game device 106 may be a personal computer. FIG. 2 shows example audio connections for such an embodiment. Referring to FIG. 2, an audio controller 202 may be connected to a personal computer 204 by a Universal Serial Bus (USB) cable 206 and a stereo audio cable 208. The personal computer may have any sort of operating system, including Android, Apple, Windows, Linux, and the like. The audio controller 202 may have a USB jack to receive the USB cable 206. The audio controller 202 may have a 2.5 mm connector, RCA connectors, or the like, to receive the stereo audio cable 208. The audio controller 202 may be connected to a smartphone 210 with a four-pole audio cable 212. The audio controller 202 may have a 2.5 mm four-pole connector, or the like, to receive the audio cable 212. The audio controller 202 may be connected to a headset 214 with a four-pole audio cable 216. The audio controller 202 may have a 2.5 mm four-pole connector, or the like, to receive the audio cable 216.

The USB cable 206 may provide power to the audio controller 202 from the personal computer 204. The audio controller 202 may exchange digital game chat audio with the personal computer 204 over the USB cable 206. The audio controller 202 may receive analog stereo game sound audio from the personal computer 204 over the stereo audio cable 208. The audio controller 202 may receive analog stereo audio, referred to herein as “mobile input audio,” from the smartphone 210, and may transmit analog monaural audio, referred to herein as “mobile output audio,” to the smartphone 210, over the four-pole audio cable 212. The mobile input audio and the mobile output audio may include music, telephony audio, notification sounds, and the like. The audio controller 202 may transmit analog stereo audio, referred to herein as “earphone audio,” to the headset 214, and may receive analog monaural audio, referred to herein as “microphone audio,” to the headset 214, over the four-pole audio cable 216.

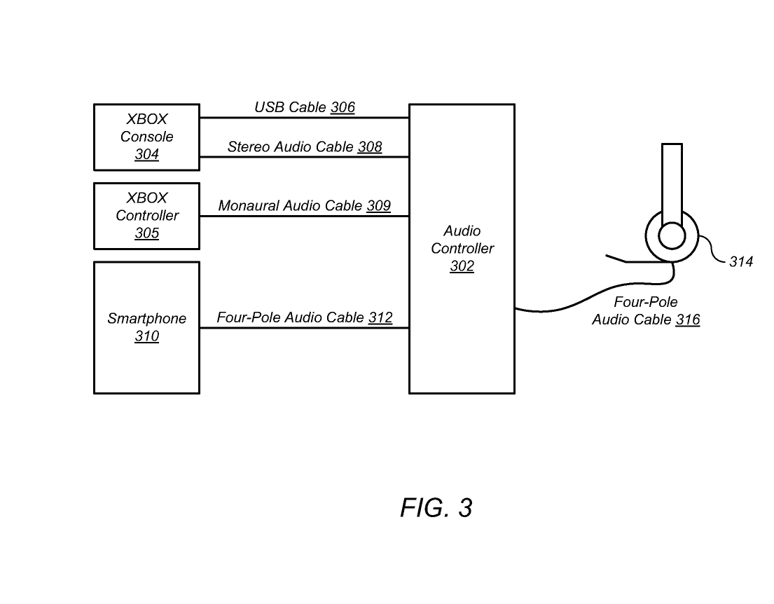

In one embodiment, the game device 106 may be an XBOX 360 device manufactured by the Microsoft Corporation of Redmond, Wash. FIG. 3 shows example audio connections for such an embodiment. Referring to FIG. 3, an audio controller 302 may be connected to an XBOX console 304 by a Universal Serial Bus (USB) cable 306 and a stereo audio cable 308. The audio controller 302 may have a USB jack to receive the USB cable 306. The stereo audio cable 308 may be an electrical cable or an optical cable. The audio controller 302 may have a 3.5 mm connector, RCA connectors, optical connector, or the like, to receive the stereo audio cable 308. The audio controller 302 may be connected to an XBOX controller 305 by a monaural audio cable 309. The audio controller 302 may have a 2.5 mm connector, or the like, to receive the monaural audio cable 309. The audio controller 302 may be connected to a smartphone 310 with a four-pole audio cable 312. The audio controller 302 may have a 3.5 mm four-pole connector, or the like, to receive the audio cable 312. The audio controller 302 may be connected to a headset 314 with a four-pole audio cable 316. The audio controller 302 may have a 3.5 mm four-pole connector, or the like, to receive the four-pole audio cable 316.

The USB cable 306 may provide power to the audio controller 302 from the XBOX console 304. The audio controller 302 may exchange monaural analog game chat audio with the XBOX controller 305 over the monaural audio cable 309. The audio controller 302 may receive game sound stereo audio from the XBOX console 304 over the stereo audio cable 308. The game sound stereo audio may be analog audio in the case of an electrical cable 308, or digital pulse-code modulation (PCM) audio in the case of an optical cable 308. The audio controller 302 may receive mobile input audio from the smartphone 310, and may transmit mobile output audio to the smartphone 310, over the four-pole audio cable 312. The audio controller 302 may transmit earphone audio to the headset 314, and may receive microphone audio to the headset 314, over the four-pole audio cable 316.

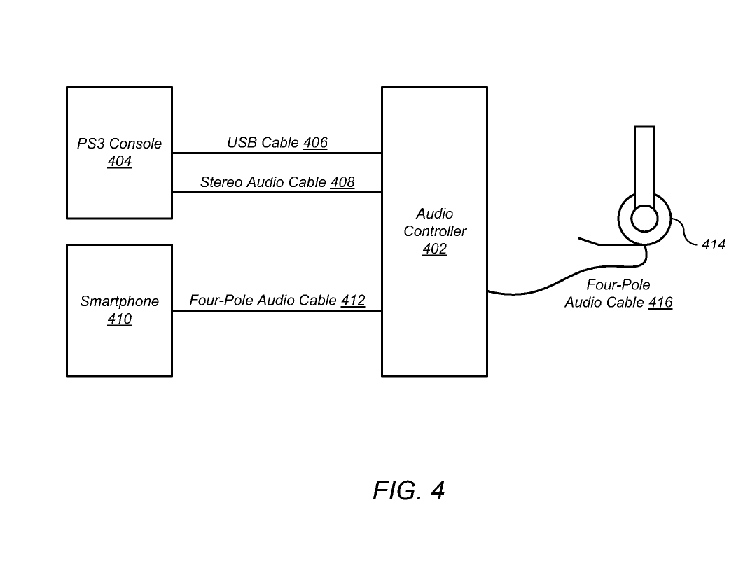

In one embodiment, the game device 106 may be a PLAYSTATION 3 (PS3) device manufactured by the Sony Corporation of Tokyo, Japan. FIG. 4 shows example audio connections for such an embodiment. Referring to FIG. 4, an audio controller 402 may be connected to a PS3 console 404 by a Universal Serial Bus (USB) cable 406 and a stereo audio cable 408. The audio controller 402 may have a USB jack to receive the USB cable 406. The stereo audio cable 408 may be an electrical cable or an optical cable. The audio controller 402 may have a 3.5 mm connector, RCA connectors, optical connector, or the like, to receive the stereo audio cable 408. The audio controller 402 may be connected to a smartphone 410 with a four-pole audio cable 412. The audio controller 402 may have a 3.5 mm four-pole connector, or the like, to receive the audio cable 412. The audio controller 402 may be connected to a headset 414 with a four-pole audio cable 416. The audio controller 402 may have a 3.5 mm four-pole connector, or the like, to receive the four-pole audio cable 416.

The USB cable 406 may provide power to the audio controller 402 from the PS3 console 404. The USB cable 406 may also provide digital stereo game chat input audio from the PS3 console 404, and may provide digital monaural game chat output audio to the PS3 console 404. The audio controller 402 may receive game sound stereo audio from the PS3 console 404 over the stereo audio cable 408. The game sound stereo audio may be analog audio in the case of an electrical cable 408, or digital pulse-code modulation (PCM) audio in the case of an optical cable 408. The audio controller 402 may receive mobile input audio from the smartphone 410, and may transmit mobile output audio to the smartphone 410, over the four-pole audio cable 412. The audio controller 402 may transmit earphone audio to the headset 414, and may receive microphone audio to the headset 414, over the four-pole audio cable 416.

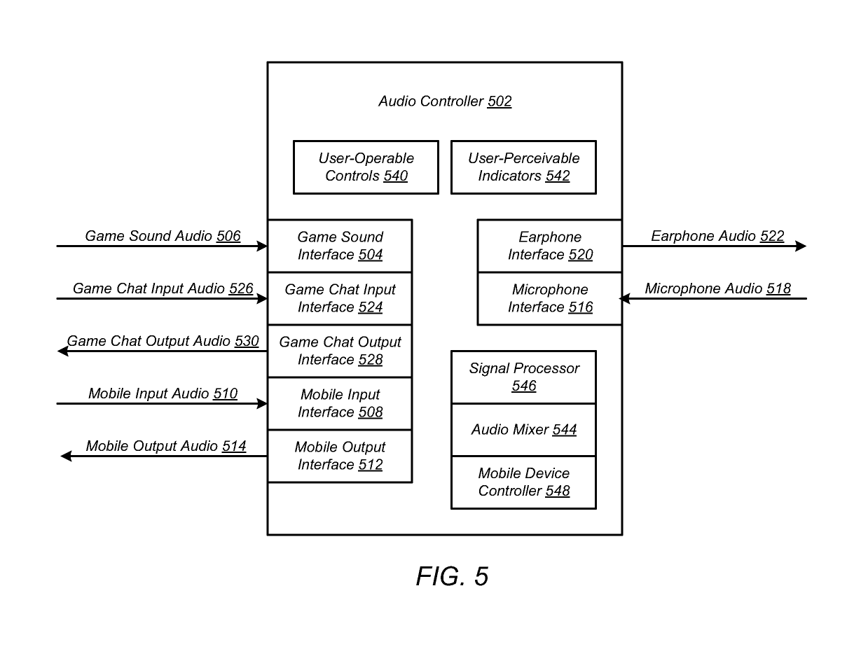

FIG. 5 shows detail of an audio controller 502 according to one embodiment. Although in the described embodiments, the elements of the audio controller 502 are presented in one arrangement, other embodiments may feature other arrangements, as will be apparent to one skilled in the relevant arts based on the disclosure and teachings provided herein. For example, the elements of audio controller 502 can be implemented in hardware, software, or combinations thereof. Referring to FIG. 5, the audio controller 502 includes a plurality of audio interfaces, user-operable controls 540, user-perceivable indicators 542, an audio mixer 544, a signal processor 546, and a mobile device controller 548. One or more elements of the audio controller 502 may be implemented as an integrated circuit. In one embodiment, the integrated circuit is the CX20709 Speaker-on-a-Chip (SPoC) manufactured by Conexant Systems, Inc. of Irvine, Calif.

The audio interfaces include a game sound interface 504 configured to receive game sound audio 506 into the audio controller 502, a mobile input interface 508 configured to receive mobile input audio 510 into the audio controller 502, a mobile output interface 512 configured to transmit mobile output audio 514 from the audio controller 502, a microphone interface 516 configured to receive microphone audio 518 into the audio controller 502, an earphone interface 520 configured to transmit earphone audio 522 from the audio controller 502, a game chat input interface 524 configured to receive game chat input audio 526 into the audio controller 502, and a game chat output interface 528 configured to transmit game chat output audio 530 from the audio controller 502.

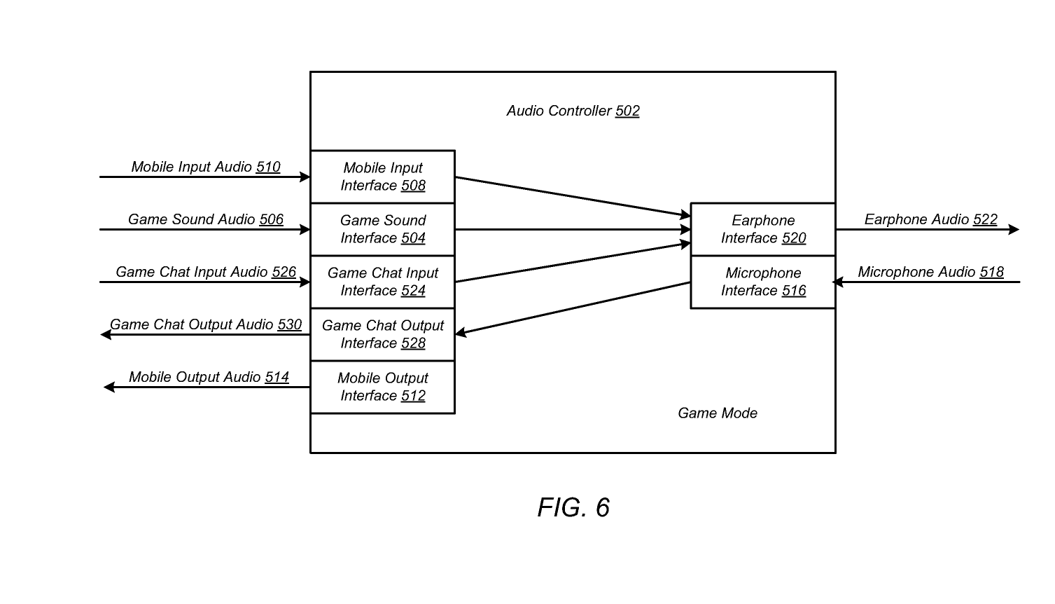

The disclosed audio controllers may operate in any of three user-selectable modes: game mode, mobile mode, and mobile mode with combo sound. FIG. 6 illustrates audio flows for the audio controller 502 of FIG. 5 when operating in the game mode according to one embodiment. Referring to FIG. 6, when operating in the game mode, the audio controller 502 provides the game sound audio 506, the game chat input audio 526, and the mobile input audio 510, to the earphone interface 520. In other words, the audio controller 502 provides the earphone audio 522 based on the game sound audio 506, the game chat input audio 526, and the mobile input audio 510. When operating in the game mode, the audio controller 502 also provides the microphone audio 518 to the game chat output interface 528. In other words, the audio controller 502 provides game chat output audio 530 based on the microphone audio 518.

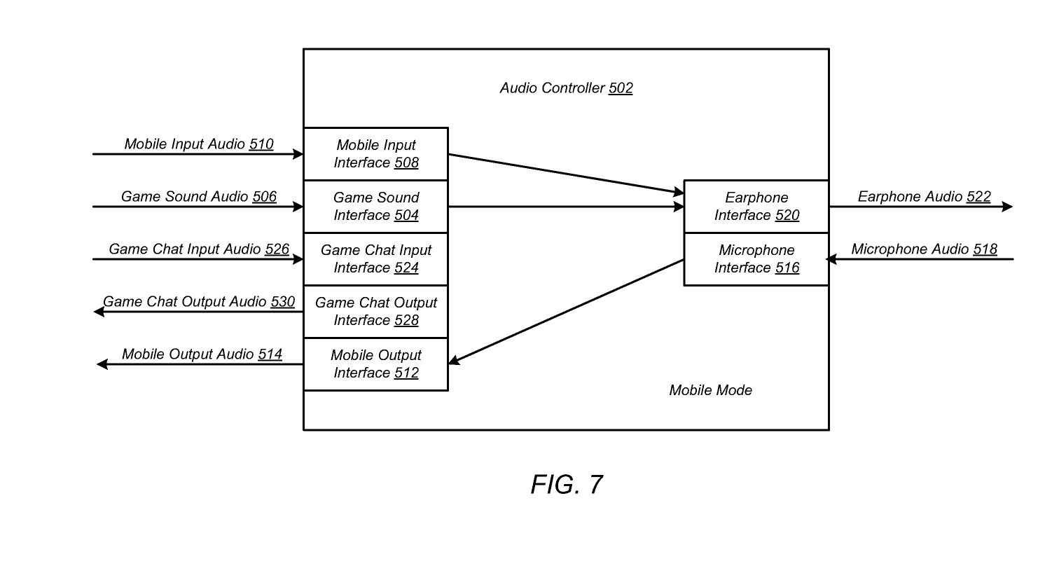

FIG. 7 illustrates audio flows for the audio controller 502 of FIG. 5 when operating in the mobile mode according to one embodiment. Referring to FIG. 7, when operating in the mobile mode, the audio controller 502 provides the game sound audio 506, and the mobile input audio 510, to the earphone interface 520. In other words, the audio controller 502 provides the earphone audio 522 based on the game sound audio 506 and the mobile input audio 510. When operating in the mobile mode, the audio controller 502 also provides the microphone audio 518 to the mobile output interface 512. In other words, the audio controller 502 provides the mobile output audio 514 based on the microphone audio 518.

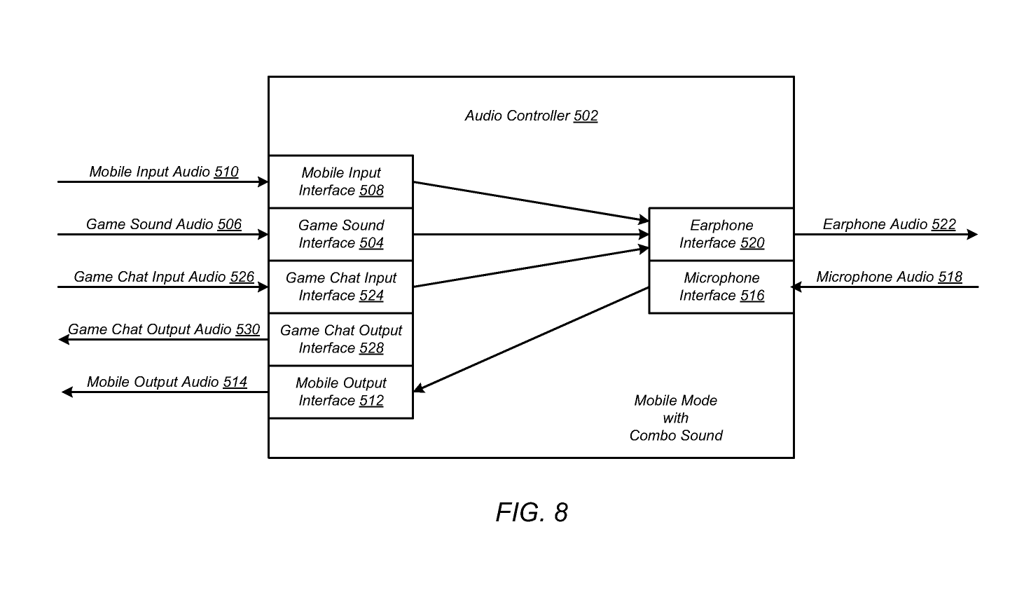

FIG. 8 illustrates audio flows for the audio controller 502 of FIG. 5 when operating in the mobile mode with combo sound according to one embodiment. Referring to FIG. 8, when operating in the mobile mode with combo sound, the audio controller 502 provides the game sound audio 506, the mobile input audio 510, and the game chat input audio 526, to the earphone interface 520. In other words, the audio controller 502 provides the earphone audio 522 based on the game sound audio 506, the mobile input audio 510, and the game chat input audio 526. When operating in the mobile mode with combo sound, the audio controller 502 also provides the microphone audio 518 to the mobile output interface 512. In other words, the audio controller 502 provides the mobile output audio 514 based on the microphone audio 518.

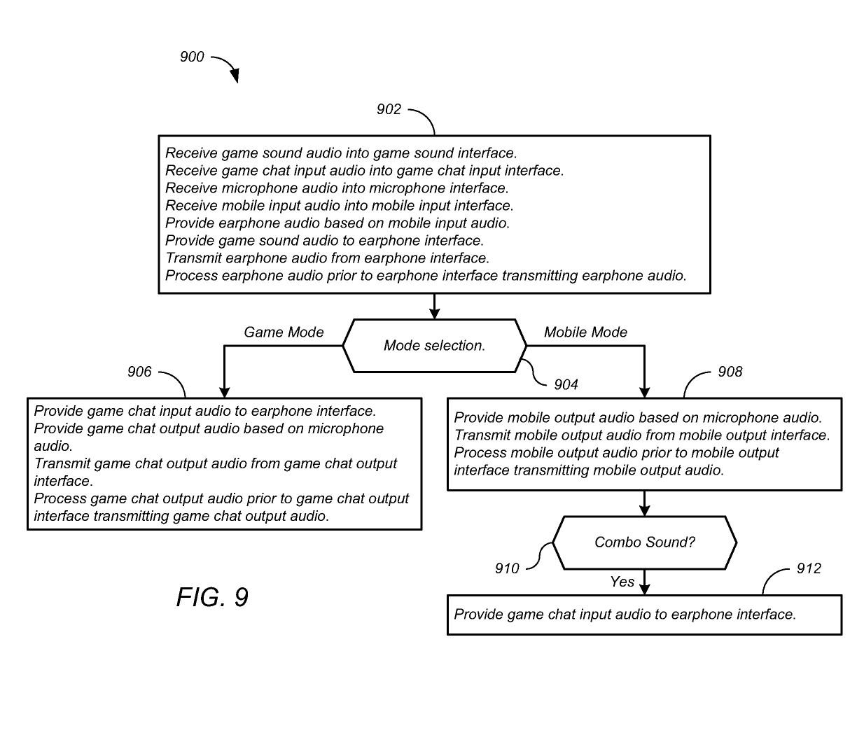

FIG. 9 shows a process 900 for the audio controller 502 of FIG. 5 according to one embodiment. Although in the described embodiments, the elements of the process 900 are presented in one arrangement, other embodiments may feature other arrangements, as will be apparent to one skilled in the relevant arts based on the disclosure and teachings provided herein. For example, in various embodiments, some or all of the steps of process the 900 can be executed in a different order, concurrently, and the like.

Referring to FIG. 9, at 902, in any of the three modes (game mode, mobile mode, and mobile mode with combo sound), the audio controller 502 may perform the functions listed below. The audio controller 502 may receive the game sound audio 506 into the game sound interface 504. The audio controller 502 may receive the game chat input audio 526 into the game chat input interface 524. The audio controller 502 may receive the microphone audio 518 into the microphone interface 516. The audio controller 502 may receive the mobile input audio 510 into the mobile input interface 508. The audio controller 502 may provide the earphone audio 522 based on the mobile input audio 510. The audio controller 502 may provide the game sound audio 506 to the earphone interface 520. The audio controller 502 may transmit the earphone audio 522 from the earphone interface 520. The audio controller 502 may process the earphone audio 522 prior to the earphone interface 520 transmitting the earphone audio 522.

If, at 904, the game mode is selected, then at 906, the audio controller 502 may perform the functions listed below. The audio controller 502 may provide the game chat input audio 526 to the earphone interface 520. The audio controller 502 may provide the game chat output audio 530 based on the microphone audio 518. The audio controller 502 may transmit the game chat output audio 530 from the game chat output interface 528. The signal processor 546 of the audio controller 502 may process the game chat output audio 530 prior to the game chat output interface 528 transmitting the game chat output audio 530.

If, at 904, the mobile mode is selected, then at 908, the audio controller 502 may perform the functions listed below. The audio controller 502 may provide the mobile output audio 514 based on the microphone audio 518. The audio controller 502 may transmit the mobile output audio 514 from the mobile output interface 512. The signal processor 546 of the audio controller 502 may process the mobile output audio 514 prior to the mobile output interface 512 transmitting the mobile output audio 514.

If, at 910, the mobile mode with combo sound is selected, then in addition to performing any of the mobile mode functions listed above, at 912, the audio controller 502 may provide the game chat input audio 526 to the earphone interface 520.

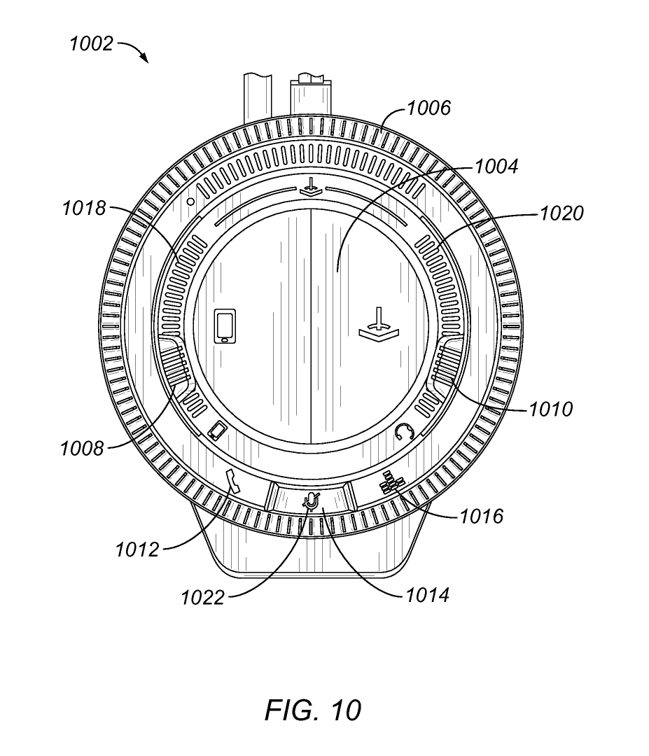

FIG. 10 shows user-operable controls and user-perceivable indicators of an audio controller 1002 according to one embodiment. Referring to FIG. 10, the user-operable controls include a rocker switch 1004, a volume dial 1006, a mobile mode slider 1008, a game mode slider 1010, a mobile device control button 1012, a mute button 1014, and an equalizer button 1016. The user-perceivable indicators include mobile mode light-emitting diodes (LEDs) 1018, game mode LEDs 1020, and a mute LED 1022.

The functions of the user-perceivable indicators and the user-operable controls of FIG. 10 will now be described with reference to the audio interfaces of FIG. 5. Referring again to FIG. 10, the rocker switch 1004 has two positions. When the right side of the rocker switch 1004 is depressed, the audio controller 1002 is placed in the game mode. Note the right side of the rocker switch 1004 bears a “joystick” icon. When the audio controller 1002 is in the game mode, the game mode LEDs 1020 glow orange. When the left side of the rocker switch 1004 is depressed, the audio controller 1002 is placed in the mobile mode. Note the left side of the rocker switch 1004 bears a “smartphone” icon. When the audio controller 1002 is in the mobile mode, the mobile mode LEDs 1018 glow blue.

The volume dial 1006 changes the gain of the earphone audio 522 when rotated. Clockwise rotation of the volume dial 1006 increases the gain, while counter-clockwise rotation decreases the gain. Rotating the volume dial 1006 to the fully counter-clockwise position turns off the audio controller 1002.

The mobile device control button 1012 may control a connected mobile device using the mobile device controller 548. For example, when a connected mobile device is operating as a phone, the mobile device control button 1012 may be used to answer and end calls. As another example, when a connected mobile device is operating as a music player, the mobile device control button 1012 may be used to play and pause the music.

The mute button 1014 may be used to mute the earphone audio 522. When the earphone audio 522 is muted, the mute LED 1022 glows red. The mute LED 1022 may also glow red when the audio controller 1002 is on, but the audio cable 212 (FIG. 2) is disconnected.

The equalizer button 1016 may be used to cycle through a plurality of equalization profiles. The signal processor 546 applies the selected equalization profile to the earphone audio 522. Each equalization profile may include audio equalization, 3D spatialization, or both. In one embodiment, the equalization profiles include a flat equalization profile, a bass boost equalization profile, and a midrange boost profile. The equalizer button 1016 may also be used, in combination with the volume dial 1006, to select mobile mode with combo sound, as described below. When the volume dial 1006 is rotated to the fully counter-clockwise position, and the equalizer button 1016 is pressed for four seconds, the audio controller 1002 toggles in and out of mobile mode with combo sound. The equalizer button 1016, the mobile mode slider 1008, and the game mode slider 1010 may be used to mix and balance the components of the earphone audio 522, as described below.

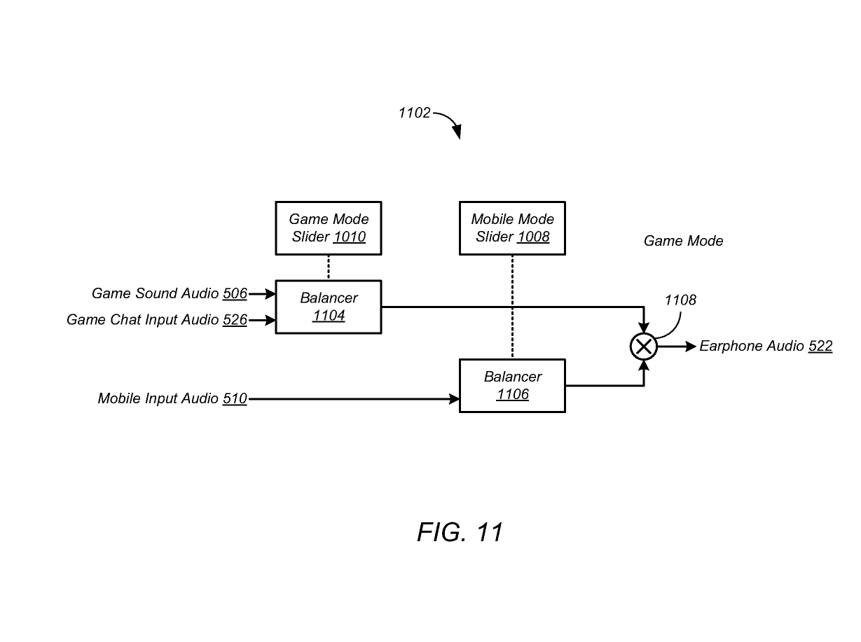

FIG. 11 illustrates mixing and balancing for the game mode according to one embodiment. Referring to FIG. 11, an audio controller 1102 includes two balancers 1104, 1106 and a mixer 1108. The first balancer 1104 changes the audio level balance between the game chat input audio 526 and the game sound audio 506 responsive to operation of the game mode slider 1010. The second balancer 1106 changes the gain of the mobile input audio 510 responsive to operation of the mobile mode slider 1008. The mixer 1108 combines the output of the balancers 1104, 1106, and provides the combination as the earphone audio 522.

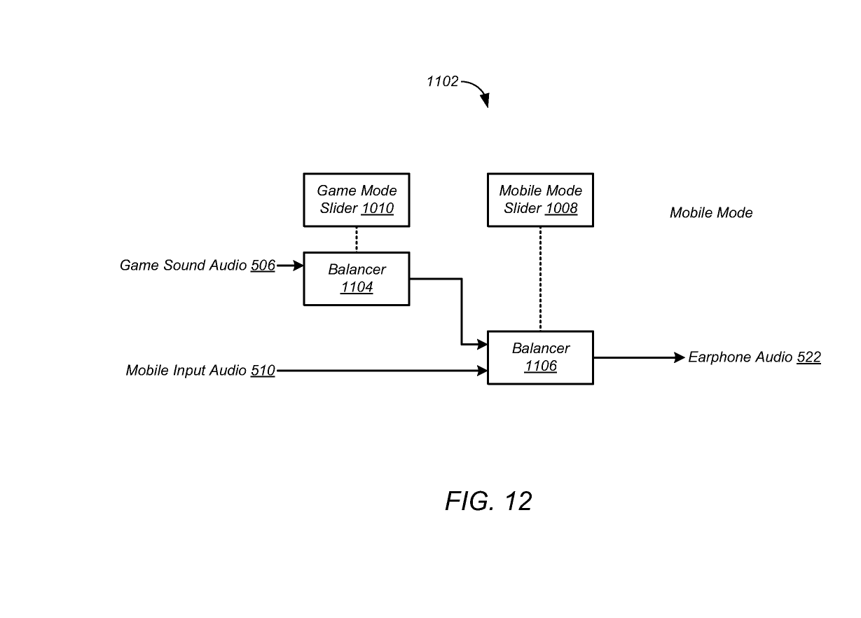

FIG. 12 illustrates mixing and balancing for the mobile mode according to one embodiment. Referring to FIG. 12, the first balancer 1104 changes the gain of the game sound audio 506 responsive to operation of the game mode slider 1010. The second balancer 1106 changes the audio level balance between the output of the first balancer 1104 and the mobile input audio 510 responsive to operation of the mobile mode slider 1008, and provides the combination as the earphone audio 522.

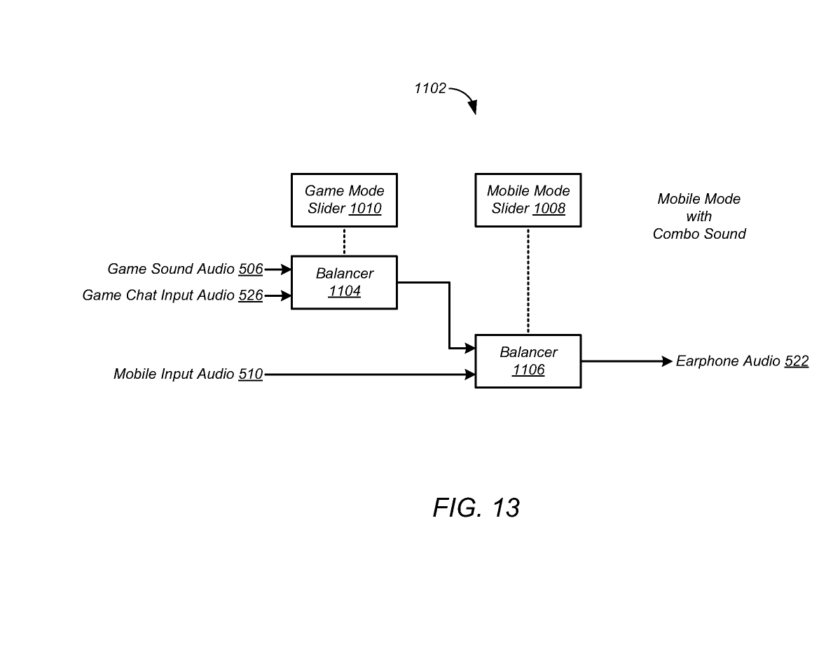

FIG. 13 illustrates mixing and balancing for the mobile mode with combo sound according to one embodiment. Referring to FIG. 13, the first balancer 1104 changes the audio level balance between the game chat input audio 526 and the game sound audio 506 responsive to operation of the game mode slider 1010. The second balancer 1106 changes the audio level balance between the output of the first balancer 1104 and the mobile input audio 510 responsive to operation of the mobile mode slider 1008, and provides the combination as the earphone audio 522.

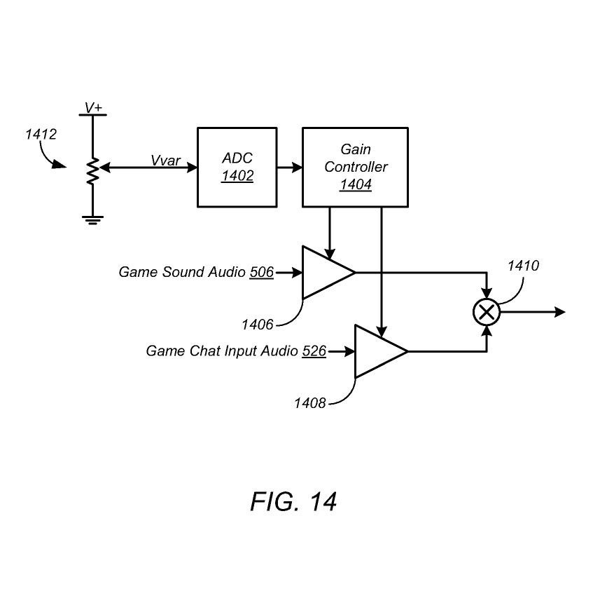

FIG. 14 shows detail of the first balancer 1104 of the audio controller 1102 of FIG. 11 according to one embodiment. For clarity, the game sound audio 506 is shown as monaural audio. Referring to FIG. 14, the game mode slider 1010 includes a potentiometer 1412 that provides a variable analog output voltage Vvar responsive to operation of the game mode slider 1010. An analog-to-digital converter (ADC) 1402 converts the variable analog output voltage Vvar to a digital voltage. A gain controller 1404 controls two variable-gain amplifiers 1406, 1408 in accordance with the digital voltage. The variable-gain amplifier 1406 varies the gain of the game sound audio 506. The variable-gain amplifier 1408 varies the gain of the game chat input audio 526. A mixer 1410 combines the outputs of the variable-gain amplifiers 1406, 1408.

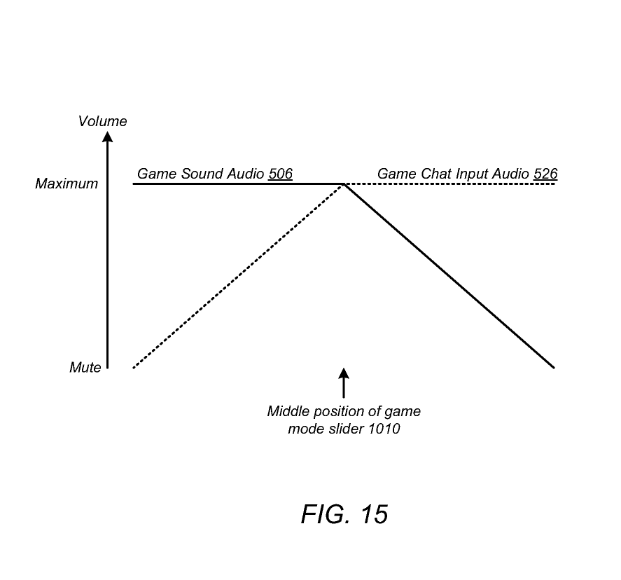

FIG. 15 shows gain profiles for the first balancer 1104 of FIG. 11 in the game mode and mobile mode with combo sound according to one embodiment. Referring to FIG. 15, the gain profile of the game sound audio 506 is shown as a solid line, and the gain profile of the game chat input audio 526 is shown as a broken line. When the game mode slider 1010 is in its middle position, the gains of both the game sound audio 506, and the game chat input audio 526, are at maximum. Moving the game mode slider 1010 counter-clockwise reduces the gain of the game chat input audio 526 gradually to zero (mute). Moving the game mode slider 1010 clockwise reduces the gain of the game sound audio 506 gradually to zero (mute).

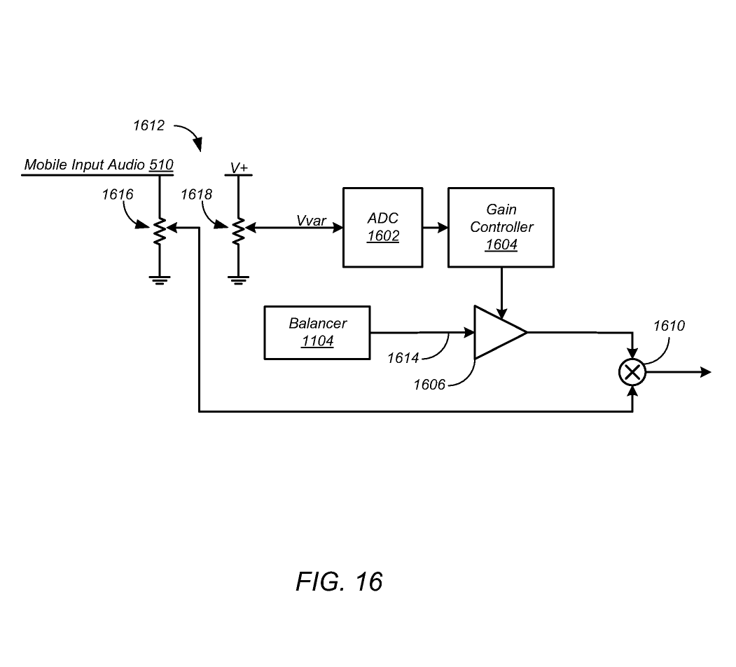

FIG. 16 shows detail of the second balancer 1106 of the audio controller 1102 of FIG. 11 according to one embodiment. For clarity, the mobile input audio 510, and the output 1614 of the first balancer 1104, are each shown as monaural audio. The output 1614 of the first balancer 1104 is referred to herein as “combo sound” audio 1614. Referring to FIG. 16, the game mode slider 1010 includes a potentiometer 1612 having two resistive tracks 1616, 1618. The position of the potentiometer 1612 along the resistive tracks 1616, 1618 is changed responsive to the operation of the mobile mode slider 1008. The first track 1616 changes the gain of the mobile input audio 510 directly, in the analog domain, according to the position of the potentiometer 1612. The second track 1618 provides a variable analog output voltage Vvar according to the position of the potentiometer 1612. An analog-to-digital converter (ADC) 1602 converts the variable analog output voltage Vvar to a digital voltage. A gain controller 1604 controls a variable-gain amplifier 1606 in accordance with the digital voltage. The variable-gain amplifier 1606 varies the gain of the combo sound audio 1614. A mixer 1610 combines the output of the variable-gain amplifier 1606 with the gain-adjusted mobile input audio 510.

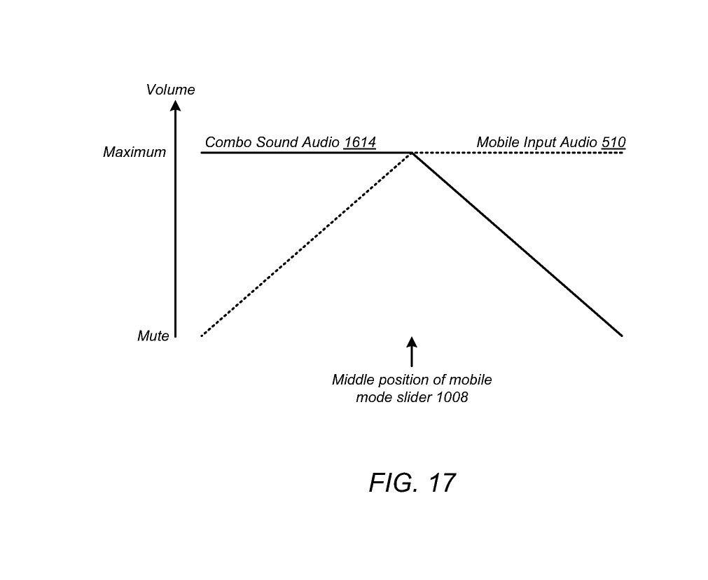

FIG. 17 shows gain profiles for the second balancer 1106 of FIG. 11 in the mobile mode with combo sound according to one embodiment. Referring to FIG. 17, the gain profile of the combo sound audio 1614 is shown as a solid line, and the gain profile of the mobile input audio 510 is shown as a broken line. When the mobile mode slider 1008 is in its middle position, the gains of both the combo sound audio 1614, and the mobile input audio 510, are at maximum. Moving the mobile mode slider 1008 counter-clockwise reduces the gain of the combo sound audio 1614 gradually to zero (mute). Moving the mobile mode slider 1008 clockwise reduces the gain of the mobile input audio 510 gradually to zero (mute).

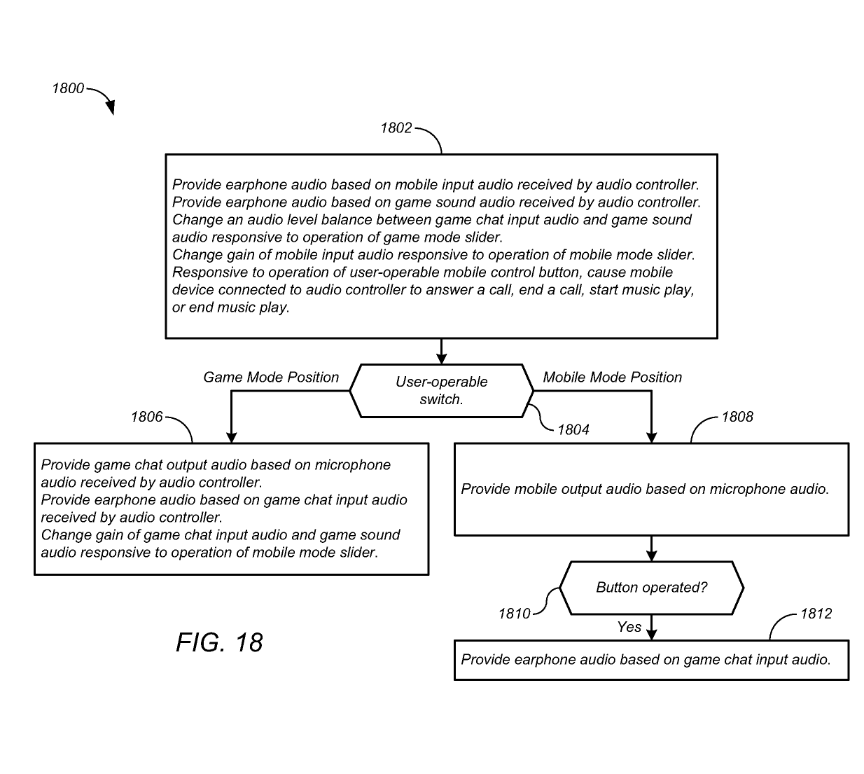

FIG. 18 shows a process 1800 for the audio controller 1002 of FIG. 10 according to one embodiment. Although in the described embodiments, the elements of the process 1800 are presented in one arrangement, other embodiments may feature other arrangements, as will be apparent to one skilled in the relevant arts based on the disclosure and teachings provided herein. For example, in various embodiments, some or all of the steps of the process 1800 can be executed in a different order, concurrently, and the like.

Referring to FIG. 18, at 1802, in any of the three modes (game mode, mobile mode, and mobile mode with combo sound), the audio controller 502 may perform the functions listed below. The audio controller 502 may provide the earphone audio 522 based on the mobile input audio 510 received by the audio controller 502. The audio controller 502 may the provide earphone audio 522 based on the game sound audio 506 received by the audio controller 502. The audio controller 502 may change an audio level balance between the game chat input audio 526 and the game sound audio 506 responsive to operation of the game mode slider 1010. The audio controller 502 may change a gain of the mobile input audio 510 responsive to operation of the mobile mode slider 1008. The audio controller 502 may, responsive to operation of the user-operable mobile device control button 1012, cause a mobile device connected to the audio controller 502 to answer a call, end a call, start music play, or end music play.

If, at 1804, the user-operable switch 1004 is in the game mode position, then at 1806, the audio controller 502 may perform the functions listed below. The audio controller 502 may provide the game chat output audio 530 based on the microphone audio 518 received by the audio controller 502. The audio controller 502 may provide the earphone audio 522 based on the game chat input audio 526 received by the audio controller 502. The audio controller 502 may change the gain of the game chat input audio 526 and the game sound audio 506 responsive to operation of the mobile mode slider 1008.

If, at 1804, the user-operable switch 1004 is in the mobile mode position, then at 1808, the audio controller 502 may provide the mobile output audio 514 based on the microphone audio 518.

If, at 1810, the mobile mode with combo sound is selected, for example using the volume dial 1006 and the equalizer button 1016 as described above, then in addition to performing any of the mobile mode functions listed above, at 1812, the audio controller 502 may provide the earphone audio 522 based on the game chat input audio 526.

While a use case for gaming and mobile devices is described in detail herein, the disclosed audio controllers may be employed in other use cases with other audio devices. For example, a user may employ the disclosed audio controllers to switch between two different subsets of players using two different communication channels/types, or two channels within the same type. As another example, a user may employ the disclosed audio controllers to connect and mix audio for a smartphone and a voice service such as Skype, Lync, or the like. As another example, a user may employ the disclosed audio controllers to connect and mix audio for components of a home entertainment system such as speakers, television sets, DVD players, and the like. Furthermore, while particular connectors have been described for the disclosed audio controllers, other connectors and/or adapters may be employed to connect to audio devices having other connectors.

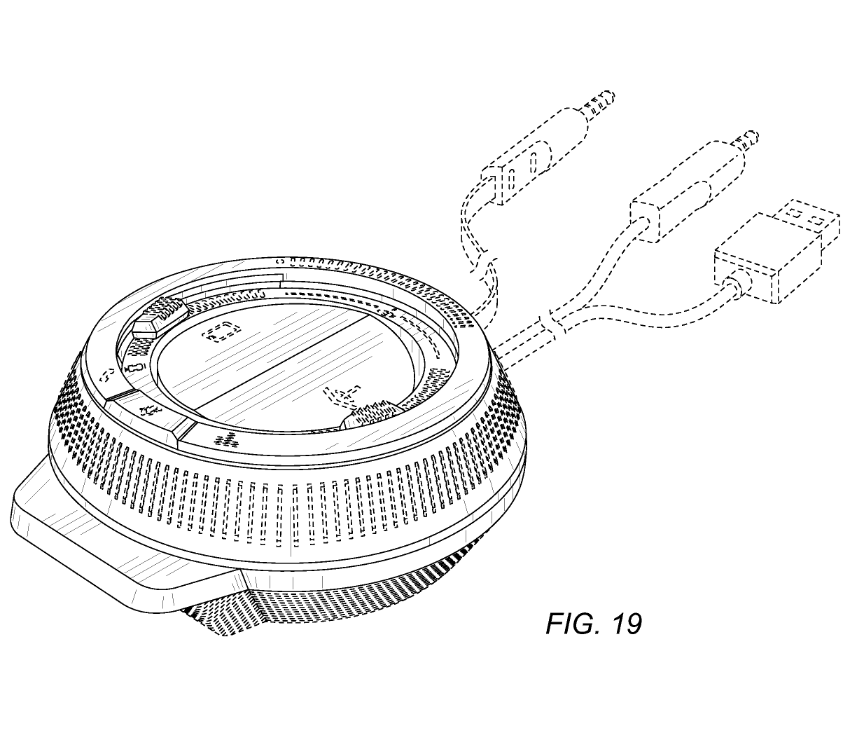

FIG. 19 is a perspective view of an audio controller device according to one embodiment.

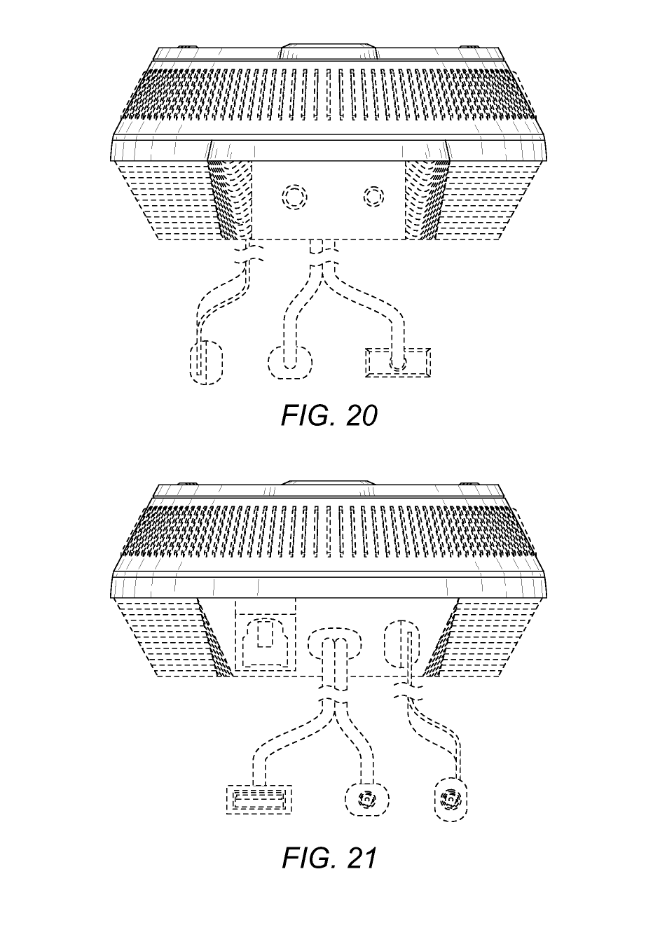

FIG. 20 is a front view of an audio controller device according to one embodiment.

FIG. 21 is a rear view of an audio controller device according to one embodiment.

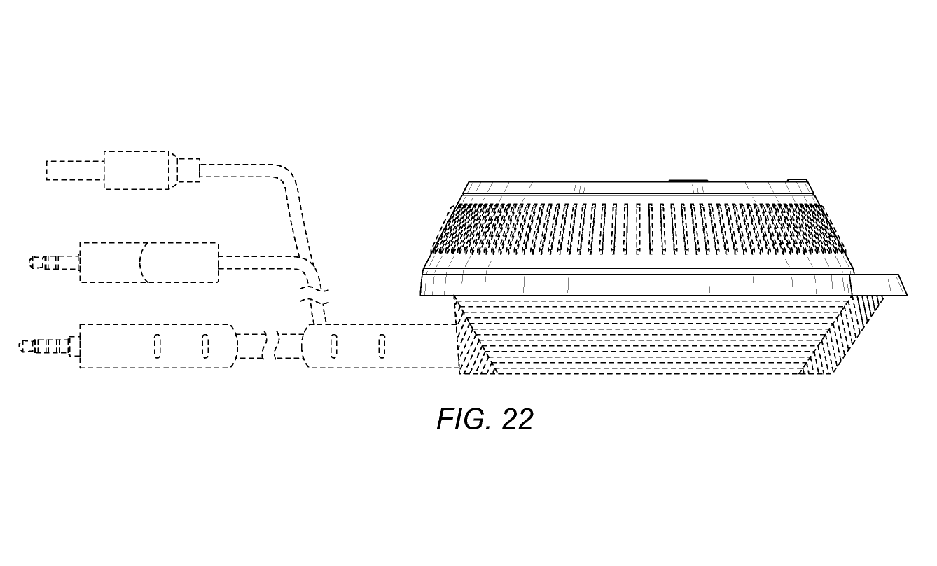

FIG. 22 is a left side view of an audio controller device according to one embodiment.

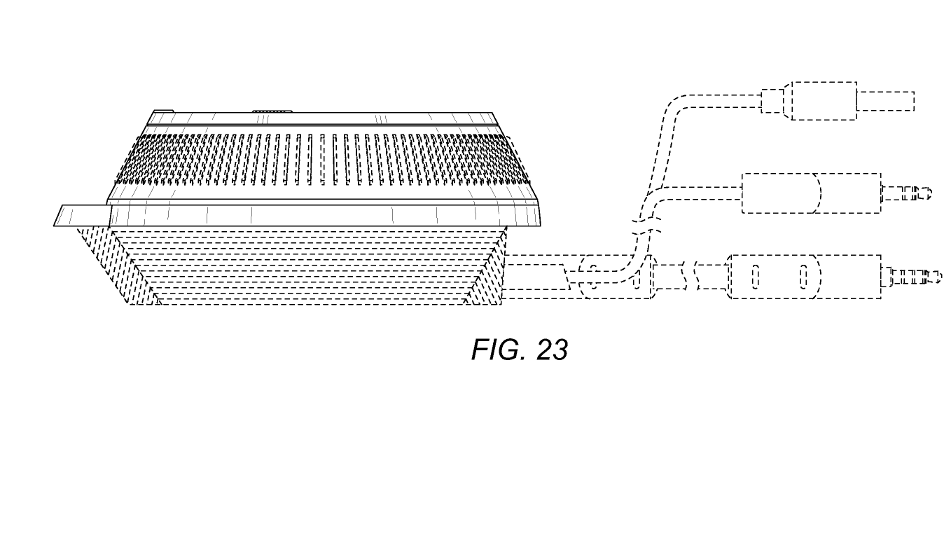

FIG. 23 is a right side view of an audio controller device according to one embodiment.

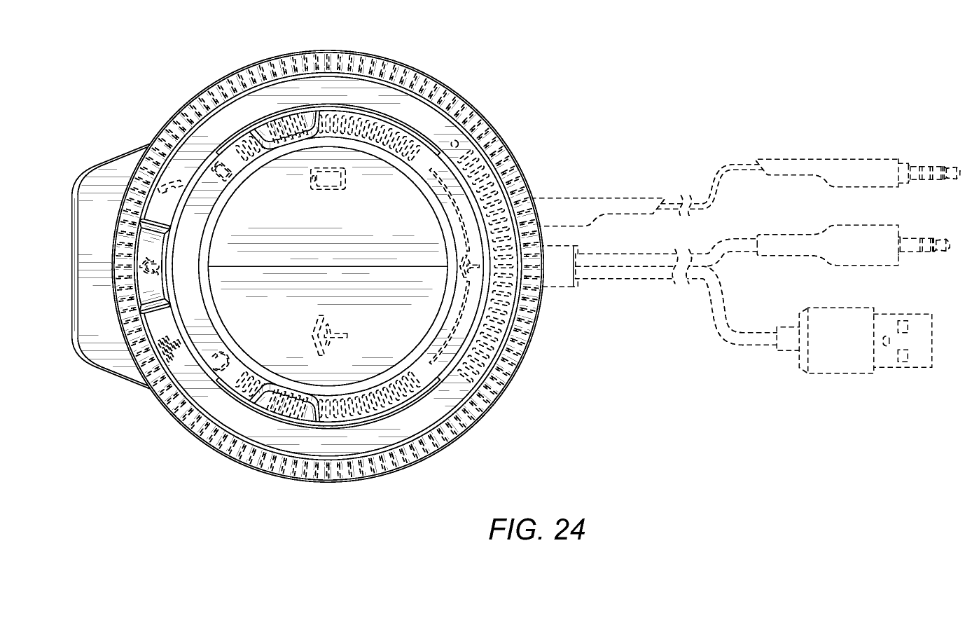

FIG. 24 is a top view of an audio controller device according to one embodiment.

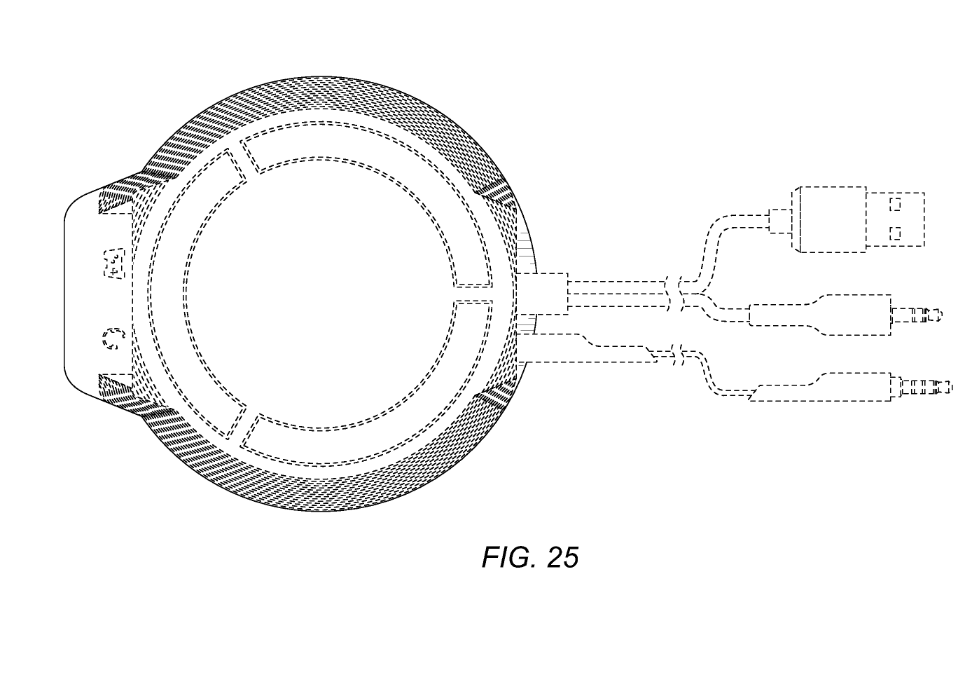

FIG. 25 is bottom view of an audio controller device according to one embodiment.

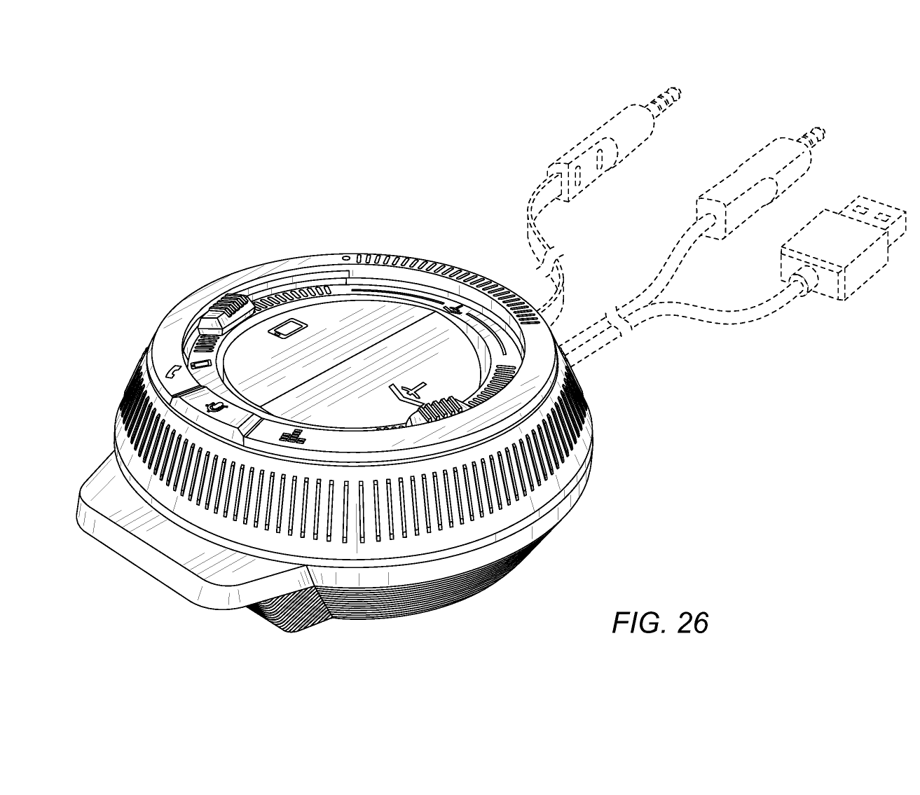

FIG. 26 is a perspective view of an audio controller device according to one embodiment.

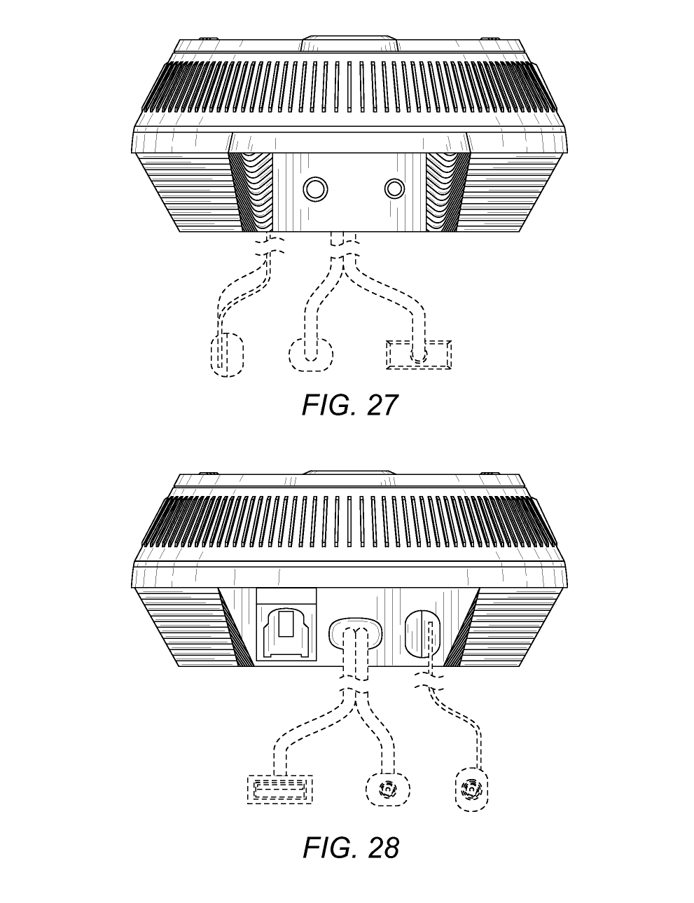

FIG. 27 is a front view of an audio controller device according to one embodiment.

FIG. 28 is a rear view of an audio controller device according to one embodiment.

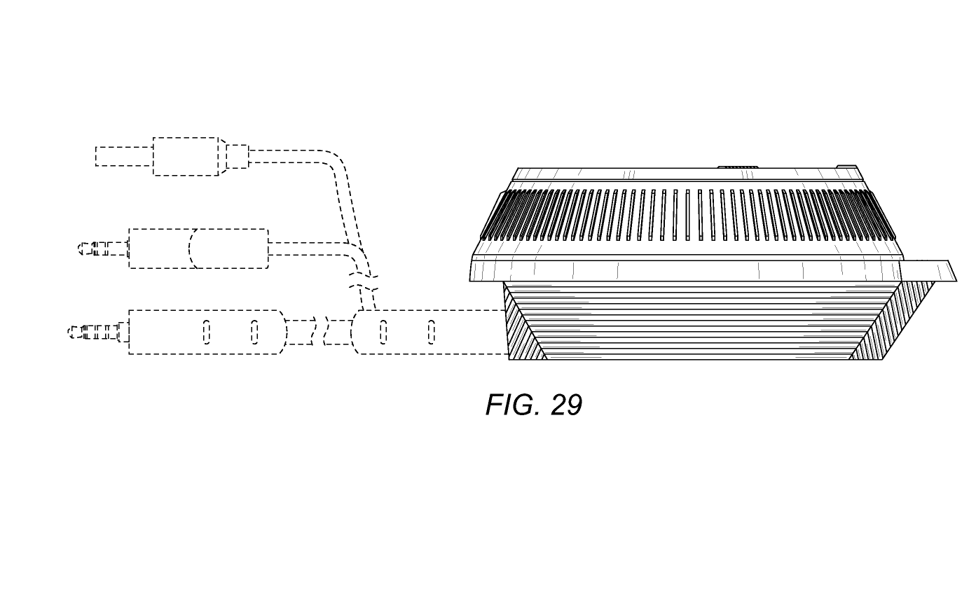

FIG. 29 is a left side view of an audio controller device according to one embodiment.

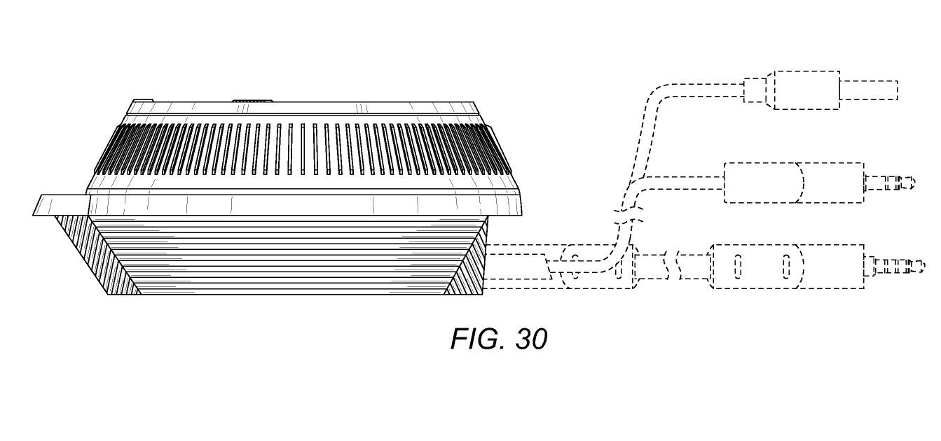

FIG. 30 is a right side view of an audio controller device according to one embodiment.

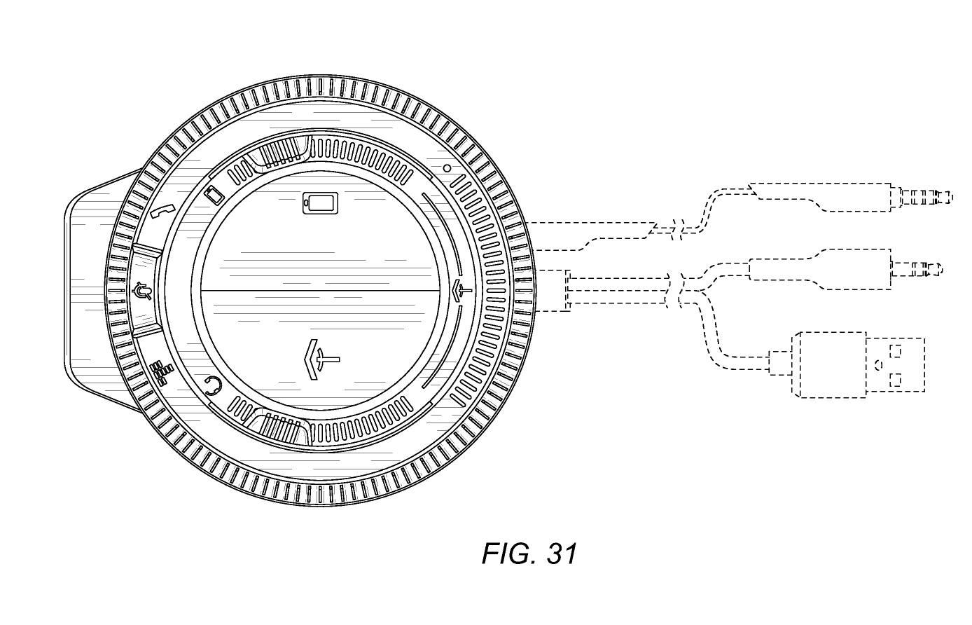

FIG. 31 is a top view of an audio controller device according to one embodiment.

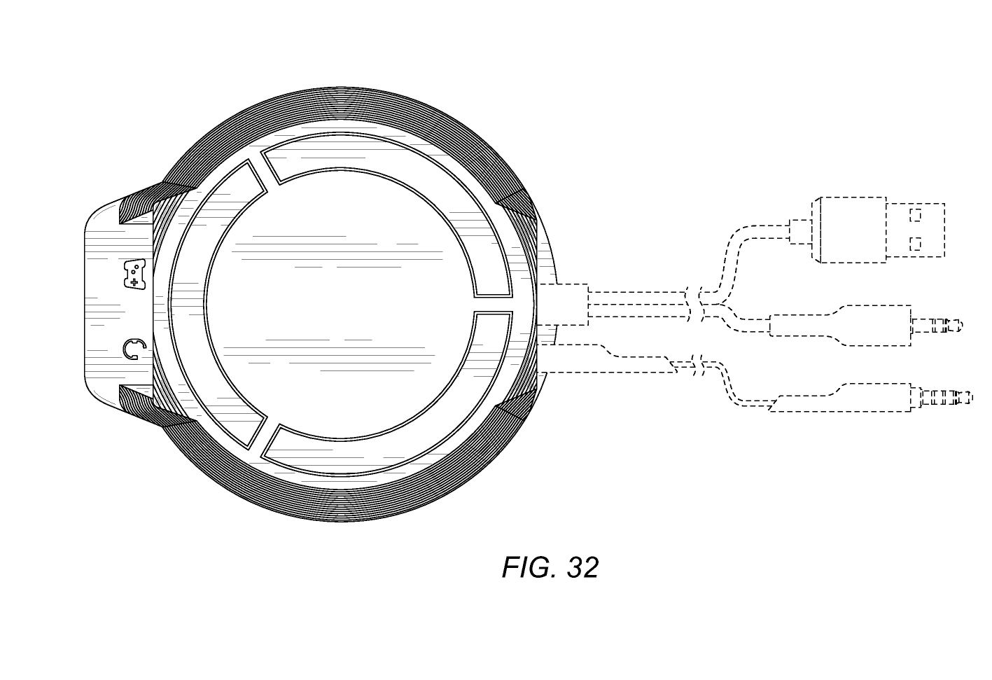

FIG. 32 is bottom view of an audio controller device according to one embodiment.

Embodiments of the disclosure can be implemented in digital electronic circuitry, or in computer hardware, firmware, software, or in combinations of them. Embodiments of the disclosure can be implemented in a computer program product tangibly embodied in a machine-readable storage device for execution by a programmable processor; and method steps of the disclosure can be performed by a programmable processor executing a program of instructions to perform functions of the disclosure by operating on input data and generating output. The disclosure can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the disclosure have been described. Nevertheless, it will be understood that various modifications may be made without departing from the spirit and scope of the disclosure. Accordingly, other implementations are within the scope of the following claims.

What is claimed is:

1. An apparatus comprising:
an audio mixer;
a game chat output interface configured to transmit game chat output audio from the apparatus;
a mobile output interface configured to transmit mobile output audio from the apparatus;
a microphone interface configured to receive microphone audio into the apparatus; and
wherein, responsive to selection of a first mode, the audio mixer is configured to provide the game chat output audio based on the microphone audio; and
wherein, responsive to selection of a second mode, the audio mixer is further configured to provide the mobile output audio based on the microphone audio.

2. The apparatus of claim 1, further comprising:
a mobile input interface configured to receive mobile input audio into the apparatus; and
an earphone interface configured to transmit earphone audio from the apparatus;
wherein the audio mixer is further configured to provide the earphone audio based on the mobile input audio.

3. The apparatus of claim 2, further comprising:
a game chat input interface configured to receive game chat input audio into the apparatus;
wherein, responsive to selection of the first mode, the audio mixer is further configured to provide the game chat input audio to the earphone interface.

4. The apparatus of claim 3, wherein:
the audio mixer is further configured to provide the game chat input audio to the earphone interface responsive to
i) selection of the second mode, and
ii) selection of a combo mixing mode.

5. The apparatus of claim 2, further comprising:
a game sound interface configured to receive game sound audio into the apparatus;
wherein the audio mixer is further configured to provide the game sound audio to the earphone interface.

6. The apparatus of claim 5, wherein the audio mixer comprises:
a balancer configured to change an audio level balance between the game chat input audio and the game sound audio.

7. The apparatus of claim 6, further comprising:
a potentiometer configured to change a gain of the mobile input audio in accordance with a position of the potentiometer.

8. The apparatus of claim 7, wherein the balancer is a first balancer, and wherein the audio mixer further comprises:
a second balancer configured to change a gain of the game chat input audio and the game sound audio in accordance with the position of the potentiometer responsive to selection of the second mode.

9. The apparatus of claim 2, further comprising:
a signal processor configured to process at least one of
i) the earphone audio prior to the earphone interface transmitting the earphone audio from the apparatus,
ii) the game chat output audio prior to the game chat output interface transmitting the game chat output audio from the apparatus, and
iii) the mobile output audio prior to the mobile output interface transmitting the mobile output audio from the apparatus.

10. The apparatus of claim 1, further comprising:
a mobile device controller configured to cause a mobile device connected to the mobile input interface to perform at least one of
i) answering a call,
ii) ending a call,
iii) starting music play, and
iv) ending music play.

11. The apparatus of claim 1, further comprising:
an integrated circuit comprising the audio mixer.

12. A method for an audio controller, wherein the method comprises:
transmitting game chat output audio from a game chat output interface of the audio controller;
transmitting mobile output audio from a mobile output interface of the audio controller; and
receiving microphone audio into a microphone interface of the audio controller;
providing the game chat output audio based on the microphone audio responsive to selection of a first mode; and
providing the mobile output audio based on the microphone audio responsive to selection of a second mode.

13. The method of claim 12, further comprising:
receiving mobile input audio into a mobile input interface of the audio controller;
transmitting earphone audio from an earphone interface of the audio controller; and
providing the earphone audio based on the mobile input audio.

14. The method of claim 13, further comprising:
receiving game chat input audio into a game chat input interface of the audio controller; and
providing the game chat input audio to the earphone interface responsive to selection of the first mode.

15. The method of claim 14, further comprising:
providing the game chat input audio to the earphone interface responsive to
i) selection of the second mode, and
ii) selection of a combo mixing mode.

16. The method of claim 13, further comprising:
receiving game sound audio into a game sound interface of the audio controller; and
providing the game sound audio to the earphone interface.

17. The method of claim 16, further comprising:
changing an audio level balance between the game chat input audio and the game sound audio.

18. The method of claim 17, further comprising:
changing a gain of the mobile input audio in accordance with a position of the potentiometer.

19. The method of claim 18, further comprising:
changing a gain of the game chat input audio and the game sound audio in accordance with the position of the potentiometer responsive to selection of the second mode.

20. The method of claim 13, further comprising:
processing, in a signal processor of the audio controller, at least one of
i) the earphone audio prior to the earphone interface transmitting the earphone audio from the apparatus,
ii) the game chat output audio prior to the game chat output interface transmitting the game chat output audio from the apparatus, and
iii) the mobile output audio prior to the mobile output interface transmitting the mobile output audio from the apparatus.

21.-40. (canceled)
